(19) United States
(12) Patent Application Publication
(10) Pub. No.: US 2026/0017606 A1
(43) Pub. Date: Jan. 15, 2026

(54) DYNAMIC PERISHABLE ITEM REPLENISHMENT WITH MINIMIZED TRAILER UTILIZATION

(71) Applicant: Walmart Apollo, LLC, Bentonville, AR (US)

(72) Inventors: Jingrui Li, Norman, OK (US); Abdullah Al Khaled, Irving, TX (US); Siva Kiran Venkata Seshachala, Bentonville, AR (US); Yashaswinee Sakharam Phatak, Bentonville, AR (US); Kasyap Vissapragada Jagannatha Sri, Bentonville, AR (US); Harshavardhan Reddy Nannur, Aubrey, TX (US)

(21) Appl. No.: 19/231,722

(22) Filed: Jun. 9, 2025

Related U.S. Application Data
(60) Provisional application No. 63/669,073, filed on Jul. 9, 2024.

(51) Int. Cl. G06Q 10/087; G06Q 10/04; G06Q 10/083

(52) U.S. Cl. CPC G06Q 10/087; G06Q 10/04; G06Q 10/083

(57) ABSTRACT

Examples provide for dynamically replenishing perishable items. Dynamic replenishment data including forecast daily demand data, current inventory data of DCs, and/or supplier constraint data. The replenishment data is used by one or more mixed integer linear programming (MILP) based model(s) to generate results, including supplier-to-recipient breakout orders dynamically adjusted in real-time based on total demand and supply imbalances with specific upper and lower bounds. The system generates results for weekly and/or daily perishable item replenishment results, including transport vehicle assignments and pallet build parameters for reducing shipping costs and minimizing the number of less than truckloads (LTLs) in shipments from suppliers. The pallet build parameters are customized at an item and/or supplier level to reduce the number of partial pallet occurrences in shipments from suppliers to further reduce transportation resource usage and determine the number of cases shipped from each supplier to each recipient for each item daily.

### BACKGROUND

Perishable items can play a significant role in a retail store's overall annual revenue. It is desirable to maintain a supply of these items within stores and distribution centers (DCs) serving those stores that is sufficient to meet customer demand. However, the current perishable item replenishment process for many stores and DCs involves a time-consuming and inefficient manual demand planning and replenishment planning using insufficient information which results in increased costs as well as excessive consumption of resources, such as human time and effort spent performing manual replenishment tasks, as well as costs due to over-utilization of delivery trucks and inefficiently shipped items. Moreover, the inefficiencies in the current manual replenishment process for multi-supplier and multi-purpose items, such as meat, fresh produce, and bakery results in high delivery costs, transportation issues, shrinkage, and inefficient pallet usage.

### SUMMARY

Some examples provide a system and method for dynamic perishable item replenishment with minimized resource usage. A replenishment and merchant manager component obtains dynamic replenishment data for a perishable item available from a plurality of suppliers for delivery to a plurality of recipients. The dynamic replenishment data includes forecast daily demand data for the perishable item at a store level and/or at a recipient level, current inventory data for the perishable item, and supplier constraint data for one or more suppliers. A first mixed integer linear programming (MILP) uses the dynamic replenishment data to calculate a minimized number of transport vehicles for transporting requested instances of the perishable item from the plurality of suppliers to the plurality of recipients in conformance with the supplier constraints while minimizing less than truckload (LTL) occurrences and transportation cost from supplier to DC. A subset of available transport vehicles for transporting the instances of the perishable item from each supplier to each recipient in the plurality of recipients is assigned to transport the items. A second MILP model generates optimized pallet build parameters using the dynamic replenishment data. The pallet build parameters are customized for each item and each supplier in the plurality of suppliers. The customized pallet build parameters enable building pallets of perishable items while minimizing the occurrence of partial pallets. A replenishment result is generated that includes the optimized pallet build parameters and assignments of items to a minimal number of transport vehicles for transporting the instances of the perishable item to the recipients with reduced transportation resource usage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for dynamic replenishment of perishable items with minimized transportation resource usage.

FIG. 2 is an exemplary block diagram illustrating a system for dynamic perishable item replenishment while minimizing transportation costs, less than truckloads (LTLs) and partial pallet occurrences.

FIG. 3 is an exemplary block diagram illustrating a system 300 for replenishment of perishable items using dynamic replenishment data.

FIG. 4 is an exemplary block diagram illustrating a replenishment and merchant manager having a mixed integer linear programming (MILP) cost minimization model and a MILP pallet minimization model.

FIG. 5 is an exemplary bloc diagram illustrating a replenishment and merchant manager including MILP optimization models for optimizing replenishment of perishable items using real-time supply and demand data.

FIG. 6 is an exemplary flow chart illustrating operation of the computing device to dynamically replenish perishable items.

FIG. 7 is an exemplary flow chart illustrating operation of the computing device to automatically build and load pallets using optimized pallet build parameters and transport vehicle assignments for dynamic perishable item replenishment.

FIG. 8 is an exemplary diagram illustrating a perishable item replenishment optimization results dashboard.

FIG. 9 is an exemplary diagram illustrating result summaries for perishable item replenishment.

FIG. 10 is an exemplary diagram illustrating dynamic weekly demand order adjustment and weekly supply order adjustment.

FIG. 11 is an exemplary table illustrating delivery costs with transport resource utilization optimization using MILP based optimization models.

FIG. 12 is an exemplary table illustrating transport vehicle utilization with transport resource utilization optimization using MILP based optimization models.

FIG. 13 is an exemplary illustration of MILP cost optimization formulations for truck optimization.

FIG. 14 is an exemplary illustration of MILP pallet optimization formulations for minimizing partial pallets.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Human users frequently devote substantial time to manual processes before placing purchase orders (POs) for perishable items to distribution centers (DCs) and/or stores. Some human users spend over half of their workweek on breaking down demand based on supply, pro-rating, re-breaking out, negotiating, and so on. These manual processes impose certain limitations that hinder accurate replenishment of perishable items, leading to excessive inventory of some perishable items as well as insufficient inventory of other items. For example, in many cases, information and logic are shared in multiple spreadsheets, adding to the complexity of the process. Moreover, fluctuations in prices of beef and other perishable items as well as the availability in real-time of these items from a variety of different suppliers poses major challenges in the allocation and tracking of product inventory. This results in inaccurate and unreliable replenishment of perishable items preventing restocking in a timely manner. Moreover, the inability to accurately predict daily and weekly supply as well as demand for individual stores, DCs, goods, and suppliers can result in excessive consumption of resources, such as delivery trucks, used to re-supply the DCs and/or stores.

The current perishable item replenishment process is manual and highly complex, leaving significant room for improvement where multiple DCs, suppliers and various different perishable items are replenished each week. Planning for replenishment is conducted weeks in advance with a daily demand forecast at the distribution center/item level, which is then aggregated to the item/organization level. Negotiations with suppliers are then conducted to obtain available supply for each item. The subsequent supplier breakdown process entails allocating the daily order to each distribution center for each item and may be regarded as the most complex and time-consuming part of the replenishment process. In order to achieve a balance between supply and demand at the item/organization level, corresponding prorations are introduced to adjust the order quantity. The final solution is then manually entered into the current order management system (OMS).

Supply of perishable items is unpredictable and often differs from demand. The supply and demand of perishable items, such as meat, are significantly impacted by fluctuations in commodity prices. During negotiations with suppliers, merchants are unable to project accurate numbers due to weekly changes in the cost of meat and other perishable items. Commodity prices are influenced by factors such as weather events, availability, animal health, and speculation. Daily demand forecasts for each DC are aggregated and negotiated with each supplier. Due to the nature of perishable item production, total supply quantities often differ from demand, requiring further adjustments to the demand of all items across all DCs. Prorates are needed across all centers. However, the current process employs a flat prorate method, leading to unnecessary increases in delivery costs and potential violations of transportation constraints.

Moreover, multiple different suppliers are frequently necessary for a store to fulfill all perishable item demands across all DCs and stores. Human users determine the availability and pricing, weather forecasts, peak seasons or shortages, and demand. Larger suppliers have the capacity to serve all DCs, while smaller suppliers can only serve a selection of DCs. Additionally, suppliers have limitations on the types of items they can provide. Mixed integer linear programming (MILP) has been utilized to address replenishment allocation problems. However, existing methods enable optimizing a single objective, such as cost reduction or profit maximization.

Dealing with partial pallet quantities is labor-intensive and time-consuming because it requires significant effort to consolidate partial pallets into full ones, which can slow down the overall process. Partial pallets can lead to inefficient use of storage space and may increase risk of product damage, resulting in additional costs and waste.

Current MILP based systems are unable to optimize on multiple objectives. Moreover, the current process only allows for up to two supplier breakouts in each DC for each item, resulting in missed opportunities to source the best combination of suppliers. This is a cumbersome and inefficient process where human users frequently devote significant time and effort to allocate and break down the negotiated supply to meet the individual demand of each DC, taking into consideration factors such as freight efficiency, required delivery dates, pro-rating, full truck loads, supply availability, and calendars. These allocations are then negotiated with suppliers, and the process is repeated in the event of any changes requested by the suppliers. This results in creation of partial pallets and utilization of less-than-full truckloads to deliver perishable items to DCs and stores, which in turn gives rise to higher delivery costs due to inefficient transportation planning by suppliers and increased shipping costs.

Referring to the figures, examples of the disclosure enable perishable item sourcing with minimized pallets and truckloads. In some examples, the system includes a multi-objective optimization model using MILP technique. The model minimizes the costs associated with item delivery, shrinkage, and waste, while also reducing the quantity of less than truckload (LTL) shipments and allowing for flexibility in the number of trucks utilized. In addition, the model considers various user-configurable rules and constraints related to supplier capacity, demand at the distribution center, transportation, product assortment, and the current business setup to reduce perishable item replenishment costs with improved efficiency that results in less time and labor consumed in perishable item replenishment at DCs and stores.

The system further enables faster generation of dynamic replenishment orders while improving user interaction with the system via the user interface. The computing device operates in an unconventional manner by generating optimal supplier-to-DC daily breakout orders in less time using fewer computing device resources, such as memory and processor resources. In this manner, the computing device is used in an unconventional way, and allows replenishment of perishable items from suppliers to recipients, such as DCs, using minimal transportation resources as well as reduced computing system resource usage, such as processor and memory usage consumed in generating purchase orders, thereby improving functioning of the underlying computing device.

In some examples, the system includes a cost optimization model and pallet optimization model that reduces LTL quantities and reduces the number of transport vehicles, such as transport trailers, used to transport goods from various supplies to one or more DCs or other recipients, as well as reduction in partial pallet occurrences. For example, the system has been shown to result in an eighty-five percent reduction in LTL quantities and a twenty-five percent reduction in the number of transport vehicles utilized in shipping, further saving thousands of hours in human time and labor.

In other embodiments, the system provides a graphical user interface (GUI) dashboard consolidating replenishment data and replenishment results, including recommended supplier-to-DC daily breakout orders, pallet build instructions for minimizing partial pallets, and truck assignments for minimizing LTL occurrences. In this manner, a user can view all relevant information in a single webpage or other UI page for improved user efficiency via UI interaction and increased user interaction performance.

Aspects of the embodiments provide a MILP based system that enables an automated process for improving working efficiency. The system eliminates shipping violations by applying supplier constraints and other rules, thereby reducing errors in replenishment order and item replenishment. The replenishment and merchant manager component further enable more than two supplier splits, minimizes shipping costs, optimizes transport vehicle (trailer) utilization, and provides an improved end-to-end user experience via the UI dashboard.

Other examples provide a system combining demand forecast and MILP optimization models to improve perishable item replenishment from multiple suppliers to multiple recipients, such as two or more DCs. The system generates supplier breakout purchase orders utilizing event driven fulfillment demand forecasting using two multi-objective models and an option generator. The system optimizes delivery of perishable item delivery costs across a network of suppliers and DCs to minimize LTL quantities and minimize partial pallet occurrences.

The system enhances demand forecasts for every item at every DC, balances supply-demand relationship considering item shelf life, and reduces waste attributable to perishable item throws. The system further maximizes trailer and pallet utilization and optimally determines breakout quantity of each perishable item from each supplier to each DC.

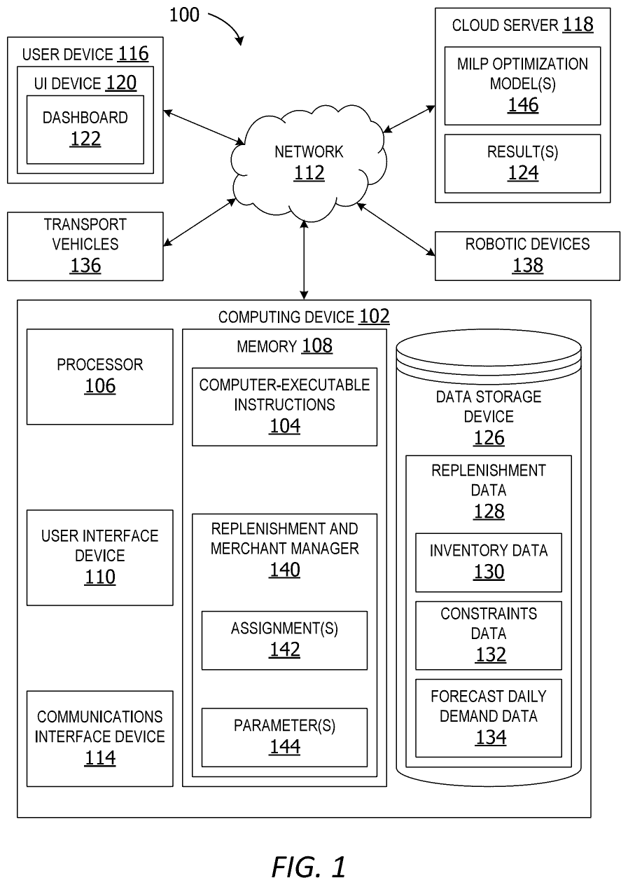

Referring again to FIG. 1, an exemplary block diagram illustrates a system 100 for dynamic replenishment of perishable items with minimized transportation resource usage. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110 for obtaining data from a user and/or providing data to a user.

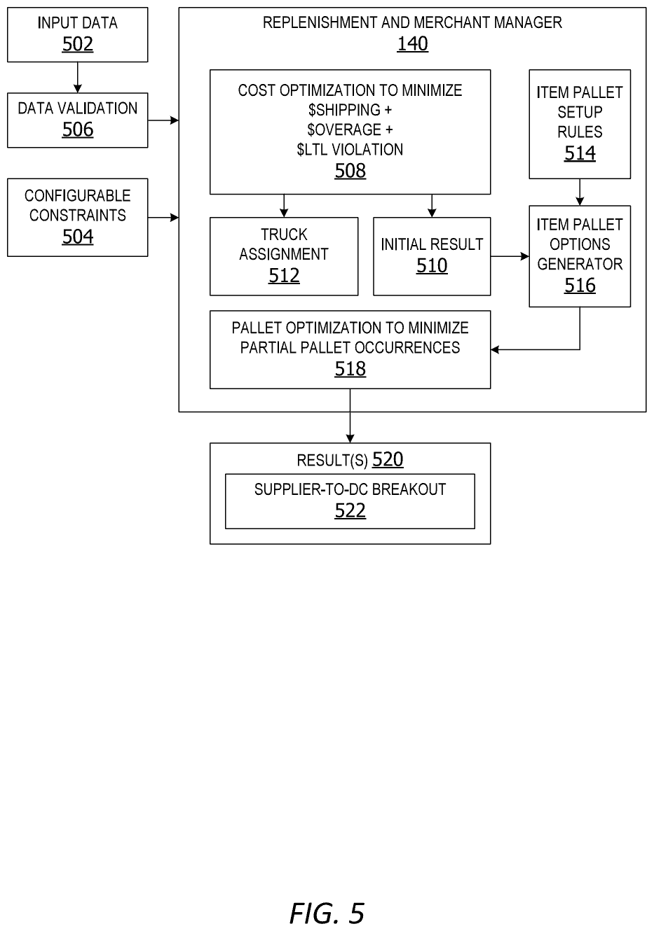

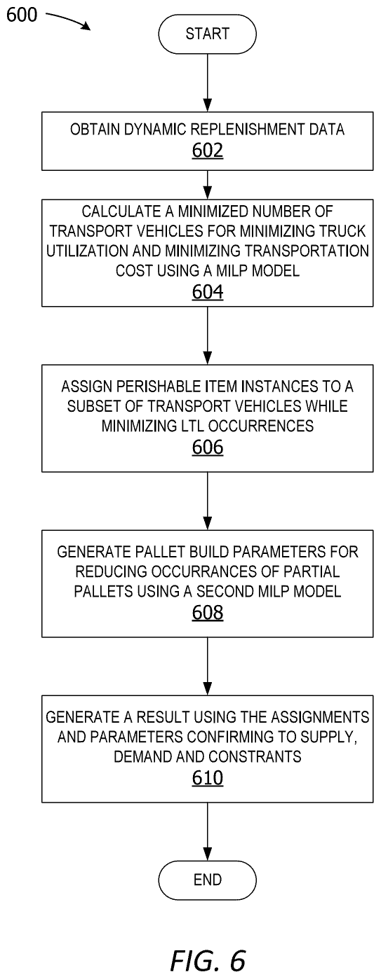

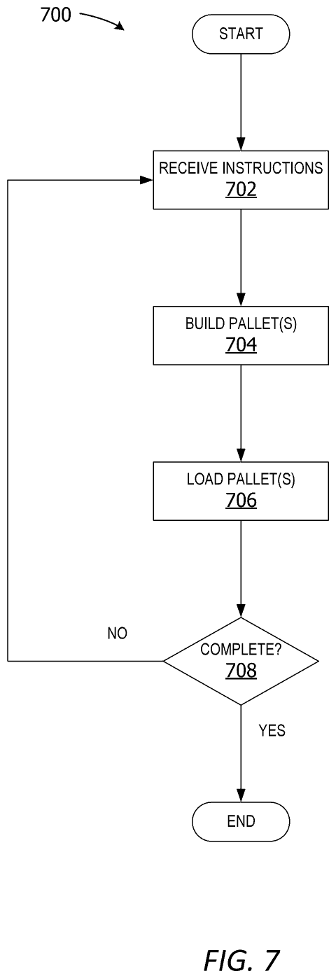

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 5, FIG. 6, and/or FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, transport vehicles 136, and/or robotic devices, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120. The UI device 120 is a user interface, such as, but not limited to, the UI device 110.

In this example, the UI device 110 obtains data from a user and/or displays or provides data to the user, such as, but not limited to, a dashboard 122. The dashboard 122 is a unified or consolidated display presenting replenishment result(s) 124 for viewing by the user. The replenishment result(s) 124 include recommended breakout orders customized for each perishable item, supplier, and/or recipient on a daily or weekly basis. A breakout order refers to the breakout assigning or allocating numbers of instances of each perishable item to be ordered from each supplier in a network of suppliers for shipment to each DC in the network of DCs or other recipients.

Perishable items include any type of item with a limited shelf life or expiration date for sale or consumption. Examples of perishable items include meat products, dairy products, bakery goods, etc. Meat can include beef items, pork items, deli items, poultry, seafood, lamb, etc. Thus, perishable items include multi-category items with hundreds of different types and varieties of items. Multiple suppliers are frequently available to supply the same perishable item to DCs and/or stores, where each supplier has different capabilities and restrictions. Perishable items include items provided for direct sales to customers as well as items used as recipe ingredients for fresh items baked, cooked or otherwise prepared within a store, such as bread, rotisserie chicken, deli items, etc. Thus, replenishment of perishable items is a complex and frequently difficult process.

The result(s) enable replenishment of perishable items from multiple suppliers to one or more recipients using minimal transportation resources, such as transportation vehicles and/or pallet building resources. Transportation vehicles may also be referred to as transportation trucks, delivery trucks, trailers, etc. A transportation vehicle includes trucks, vans, or any other type of vehicle for transporting perishable items. In some examples, the transportation vehicles include temperature controlled trailers for transporting frozen foods and/or items requiring refrigeration for cold-chain compliance.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The transport vehicles 136 includes one or more transport vehicles for transporting pallets and/or cases of instances of one or more perishable items provided by one or more suppliers to one or more recipients, such as DCs. In this example, the transport vehicles 136 includes smart vehicles having a network router or cellular router enabling a computing device on the transport vehicle to communicate with the user device 116 and/or the cloud server 118 via the network 112. In other examples, the transport vehicles 136 include vehicles which do not include a router or modem. In still other examples, the transport vehicles include autonomous or semi-autonomous vehicles. The autonomous or semi-autonomous vehicles include driverless vehicles or other drone devices which are fully automated and operated by a computing device without a human operator for transporting items and/or pallets of items.

The robotic devices 138 includes one or more robotic devices for building pallets without human intervention or with minimal human intervention. In other examples, the robotic devices 138 includes one or more robotic devices for loading pallets and/or cases of instances of items into a transport vehicle, such as an autonomous or semi-autonomous transport truck trailer for transport to a recipient without human intervention or with minimal human intervention.

The system 100 can optionally include a data storage device 126 for storing data, such as, but not limited to dynamic replenishment data 128. The replenishment data 128 includes current inventory data 130 for one or more recipients, constraints data 132 for one or more suppliers of perishable items, and/or forecast daily demand data 134 for one or more perishable items at one or more stores and/or recipients. A recipient is a distribution center, warehouse, or store receiving a shipment of replenishment items, such as instances of perishable items transported via transport vehicles from one or more suppliers.

Inventory data 130 includes data associated with current inventory of stores and/or DCs. The inventory data 130 optionally includes starting and closing inventory levels, projected inventory levels, as well as aggregated inventory levels at multiple stores and/or multiple DCs supporting the stores. In some examples, the system uses real time inventory data 130 to generate micro-batch replenishment orders and streamline replenishment of prepared products using sales quantity signals instead of manual raw material ordering for recipe items. The EDF forecast plan takes item forecast at the store level and aggregates to the supporting DCs of those stores using the real-time inventory data 130.

Constraints data 132 is data associated with constraints associated with supplier-to-recipient perishable item replenishment. Constraints data 132 includes item-level constraints, store level constraints, supply chain constraints, DC level constraints, as well as any other type of constraints. Constraints include rules, limitations, requirements, and other factors which are considered when selecting suppliers to provide replenishment items for one or more specific recipients and/or recipient locations. Constraints data 132 includes any type of data constraining replenishment from suppliers to specific recipients, such as number of delivery trucks available, types of items provided by the supplier, minimum order requirements, maximum order requirements, capacity of delivery trucks, distance delivery trucks can travel (delivery range), any specific assortment constraints for the supplier, DC, and/or the item, as well as any other types of constraints. Demand/supply prorate at different levels.

Forecast daily demand data 134 is data associated with predicted future demand for perishable items at an item level, store level, and/or a recipient level, such as a DC level. The forecast daily demand data 134 is updated in real-time based on daily sales and/or other demand-related data.

The data storage device 126 can include one or more different types of data storage devices, such as, for example, one or more rotating disks drives, one or more solid state drives (SSDs), and/or any other type of data storage device. The data storage device 126 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 126 includes a database.

The data storage device 126 in this example is included within the computing device 102, attached to the computing device, plugged into the computing device, or otherwise associated with the computing device 102. In other examples, the data storage device 126 includes a remote data storage accessed by the computing device via the network 112, such as a remote data storage device, a data storage in a remote data center, or a cloud storage.

The memory 108 in some examples stores one or more computer-executable components, such as, but not limited to, a replenishment and merchant manager 140. The replenishment and merchant manager 140 is a software component that is executed by the processor 106 of the computing device 102. The replenishment and merchant manager 140 obtains dynamic replenishment data from the data storage device 126. However, the embodiments are not limited to obtaining replenishment data from the data storage device 126.

In other examples, the replenishment and merchant manager 140 obtains the replenishment data from a remote server or other remote data storage device, such as, but not limited to, the cloud server 118 and/or the user device 116. The replenishment and merchant manager 140 calculates a minimal number of transport vehicles that is sufficient to transport all requested instances of the perishable item from the selected suppliers to the recipients while remaining in conformance with the supplier constraints identified in the constraints data 132. The replenishment and merchant manager 140 assigns the instances of the perishable item requested from the suppliers to a subset of vehicles in the transport vehicles 136 that are currently available for transporting the requested instances of the perishable item from each supplier to each recipient. In other words, the system generates optimized assignment(s) 142 of transport vehicles from suppliers to recipients to ensure the fewest number of transport vehicles are used to deliver the perishable items from the suppliers to the DCs or other recipients while minimizing transportation cost and remaining in compliance with supplier agreements and other constraints in the constraints data 132. Minimizing transportation costs is also related to the supply and demand allocation optimization.

In other examples, the replenishment data 128 generate optimized pallet build parameters customized for each item. The parameter(s) 144 include instructions for building a plurality of pallets for transporting the instances of the perishable item requested from each supplier using a minimum number of partial pallets. The replenishment and merchant manager 140 generates one or more replenishment result(s) 124 including the optimized pallet build parameter(s) 144 for building the plurality of pallets with the fewest number of partial pallets and assignment(s) 142 of the plurality of pallets from the suppliers to the subset of transport vehicles for shipping using fewer LTLs and partial pallets.

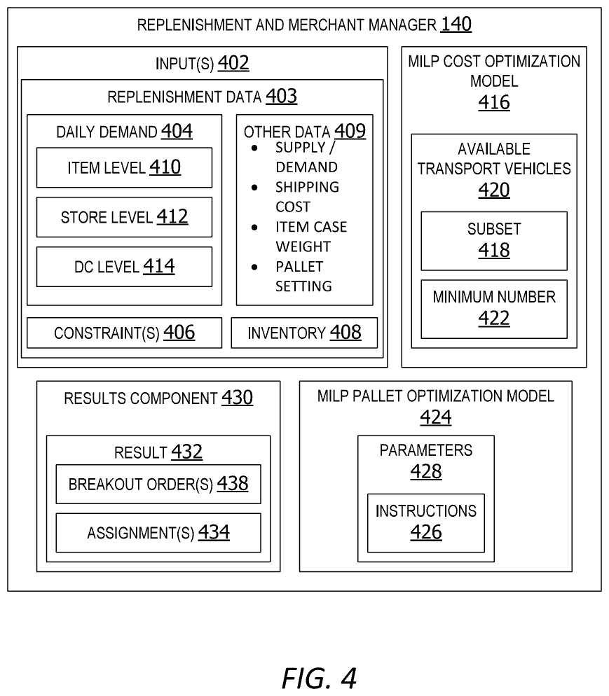

In this example, the system includes one or more mixed integer linear programming (MILP) optimization models 146 hosted on the cloud server 118. The replenishment and merchant manager 140 exchanges data with the MILP optimization models 146 via the network. However, in other examples, the one or more MILP optimization models 146 are integrated within the replenishment and merchant manager 140, as is shown in FIG. 4 below. In still other examples, the cloud server obtains the assignment(s) 142 and/or parameter(s) 144 from the computing device 102 and generates the result(s) 124 for presentation to one or more users via a UI device, such as, but not limited to, the UI device 120 and/or the UI device 110.

MILP is a type of mathematical optimization technique that involves linear equations with some, or all variables restricted to take on integer values. The technique can be used to solve complex supply chain problems, including production planning, inventory management, distribution network design, and transportation scheduling. The MILP optimization model(s) 146 involve a linear objective function, linear constraints, and integer decision variables that allow for discrete decisions to be made. It is good at solving multi-dimensional problems such as those involving multiple products, suppliers, and/or DCs for a certain planning horizon. The replenishment and merchant manager component includes one or more MILP optimization model(s) 146 that can also consider various constraints, such as capacity constraints and production constraints, to ensure that the generated results are feasible and practical.

The system enables optimizing multiple objectives, including minimizing costs for the current planning horizon and mitigating the risk of future shipping cost increases. One way to achieve this is by optimally allocating the cases from each supplier to each DC for each item and penalizing suppliers for providing LTL quantities without imposing restrictions on the number of trailers the suppliers can offer.

In some examples, the system 100 consists of two MILP models. The first MILP based model is a cost optimization model, which can also be referred to as a delivery cost optimization model. The first MILP based model, which is the cost optimization model, minimizes the delivery cost within the network of suppliers and/or DCs and optimizes utilization of transport vehicles to reduce both the delivery cost and number of less than truckload (LTL) quantity for a given set of deliveries from one or more suppliers to one or more recipients, such as DCs. The second MILP based model is a pallet optimization model that optimizes pallet build to reduce the number of partial pallet occurrences required for the deliveries. The system includes a number of business and physical constraints, as well as user adjusted parameters. The system 100 optimizes delivery costs from suppliers of meat and other perishable items to store distribution centers. Each distribution center in the network has both daily and weekly capacities and replenishment requirements. The system incorporates supplier constraints and other rules, while allowing a user to alter several factors to adjust the results to their preference. This enables the system to generate results which are customized based on the specific suppliers, DCs, perishable items, and time period (daily/weekly), as well as being tailored to specific needs of each user via the user-configurable constraints.

In some examples, the system 100 is utilized to optimize replenishment of meat products, such as ground beef, ribs, and other types of meat products. The replenishment and merchant manager component includes a multi-objective optimization model that uses MILP methods. The MILP model(s) generate optimal daily breakout orders for each beef item, considering the specific needs and requirements of each DC. Inputs for the MILP model(s) include event-driven fulfillment (EDF) demand forecasts, real-time inventory data from the enterprise inventory (EI) system, and a negotiation agreement with suppliers. In this manner, the system improves meat sourcing process by optimally assigning the daily quantity from each supplier to each DC for each perishable item stock keeping unit (SKU).

A SKU is a unique item identifier (UID). However, an item UID is not limited to an SKU. In other examples, the UID can include a barcode, a serial number, a universal product code (UPC) or any other type of UID for identifying an item and/or supplier of an item.

In some embodiments, the base cost optimization model is defined as follows:

$$Min : {\sum }_{i ∈ 𝒮} {\sum }_{j ∈ W} {\sum }_{k ∈ M} {\sum }_{t ⊆ 𝒯} ( {α}_{i}^{k} + {β}_{ij} ) {x}_{ijt}^{k} {ρ}^{k} + {\sum }_{i ∈ 𝒮} {\sum }_{j ∈ W} {\sum }_{t ⊆ 𝒯} ( {Ty}_{ijt} - {\sum }_{k ∈ M} {x}_{ijt}^{k} {ρ}^{k} )$$

where the base model shown above is subject to constraints. The first optimization model aims to minimize system delivery costs and maximize truck utilization by employing a multi-objective function. The model generates an initial solution for daily breakout orders for each item, considering the specific needs and requirements of each DC. The scope of the model contains the following sets: S is the set of suppliers.

The replenishment and merchant manager optimization model, in some embodiments, contains the following sets of constraints, where the variable [symbol] is set of suppliers for ∀i∈ [symbol] . [symbol] is set of DCs for ∀j∈ [symbol] . [symbol] is the set of all perishable items for ∀k∈ [symbol] . [symbol] is set of days in the planning horizon for ∀t∈ [symbol] .

It also defines a set of parameters.

$${a}_{i}^{k}$$

is the overage cost per case for item k from supplier i. βᵢⱼ is shipping cost per case from supplier i to DC j. ρ^{k} is the weight or average case weight for each item k in pounds (lb). γ is the prorate upper bound and η is the prorate lower bound. The term

$${α}_{i}^{k}$$

indicates handling cost for item k from supplier I($/lb).

$${D}_{j 𝓉}^{k}$$

is the daily projected demand at DC j for item k on day t.

$${U}_{i}^{k}$$

is weekly capacity of supplier i for item k. λ is penalty cost for LTL quantity per pound ($/lb). The term vᵢⱼ is minimum weekly cases from a supplier i to a DC j. θ₁ is penalty cost for each unit of unshipped case from supplier. θ₂ is penalty cost for each extra case shipped from supplier. T is full truck load quantity or trailer weight limit measured in pounds. The value of T, in one non-limiting example, is equal to forty thousand pounds (40,000 lbs).

$${a}_{i}^{k}$$

is a binary indicator for supper i's availability to serve item k. bᵢⱼ is another binary indicator for supplier i's capability to delivery to DC j.

The configurable parameters in the cost optimization model include weekly item prorate, which is represented by the term δ^{k}. The weekly gap between projected demand and supply availability is defined as:

$${δ}^{k} = {\sum }_{i ∈ S} {U}_{i}^{k} - {\sum }_{j ∈ W {\sum }_{t ∈ T}} {D}_{jt}^{k}$$

The model includes other parameters, such as the daily demand prorate adjustment γ for item k∈ [symbol] at DC j∈ [symbol] . The parameter

$${δ}_{j}^{k}$$

is the weekly DC/item demand prorate adjustment for item k∈ [symbol] at DC j∈ [symbol] . The parameter Tⱼ represents weekly DC demand prorate adjustment at DC j∈ [symbol] . The parameter θⱼₜ is day of week (DOW) DC demand prorate adjustment at DC j∈ [symbol] at day t. The set of perishable items M can be calculated as follows:

$$M = {\sum }_{i ∈ S} {\sum }_{k ∈ S} {U}_{i}^{k}$$

The decision variable

$${x}_{ijt}^{k}$$

is a non-negative integer variable which determines the daily case number ordered from each supplier i to each DC j for each perishable item. The variable γᵢⱼₜ is a non-negative variable which indicates the number of trailers from a supplier i to a DC j on a given day t.

In some examples, the system aims to solve the supplier breakout problem where the objective function is to minimize the delivery cost while maximizing the trailer utilization by reducing the LTL quantity with penalty cost.

The base cost model, in some embodiments, is defined as follows:

$$Min {\sum }_{i ∈ S} {\sum }_{j ∈ W} {\sum }_{k ∈ M} {\sum }_{t ∈ T} ( {α}_{i}^{k} + {β}_{ij} ) {x}_{ijt}^{k} {ρ}^{k} + {\sum }_{i ∈ S} {\sum }_{j ∈ W} {\sum }_{t ⊆ T} ( {Ty}_{ijt} - {\sum }_{k ∈ M} {x}_{ijt}^{k} {ρ}^{k} )$$

The model is subject to constraints, such as the following examples of constraints:

$${\sum }_{j ∈ W} {\sum }_{t ∈ T} {x}_{ijt}^{k} = {U}_{i}^{k} \qquad ∀ i ∈ S , k ∈ M$$

where this equation guarantees that the total weekly quantity of all items delivered to all DCs aligns with the quantity proposed by the supplier. Another constraint, in some examples, includes the following:

$${\sum }_{k ∈ M} {x}_{ijt}^{k} {ρ}^{k} \leq {Ty}_{ijt} \qquad ∀ j ∈ W , t ∈ T , k ∈ M$$

This equation builds the relationship between orders and trucks. The following equation enforces the constraint on the assortment of suppliers and items:

$${\sum }_{j ∈ W} {\sum }_{t ∈ T} {x}_{ijt}^{k} \leq {U}_{i}^{k} {a}_{i}^{k} \qquad ∀ i ∈ S , k ∈ M$$

The following equation ensures the assortment between suppliers and DCs or other recipients:

$${\sum }_{K ∈ M} {\sum }_{t ∈ T} {x}_{ijt}^{k} \leq {M}_{bij} \qquad ∀ i ∈ S , j ∈ W$$

In some embodiments, the equation below stipulates that when a supplier ships to a DC or other recipient, the total quantity shipped must exceed the minimum quantity, which is shown as follows:

$${\sum }_{K ∈ M} {\sum }_{t ∈ T} {x}_{ijt}^{k} \geq {V}_{ij} {b}_{ij} \qquad ∀ i ∈ S , j ∈ W$$

Suppliers may not always be able to meet demand; a merchant often needs to accept more than demand if the supplier has excess supply. However, perishable items have a limited shelf life, without proper distribution, there can be a lot of waste. Therefore, it is important for the model to allow for customized prorate at different levels. The four equations below establish various levels of demand prorate controls. Specifically, the following equation outlines the daily level of demand prorate, which is as follows:

$$⌊ {\sum }_{I ∈ S} {x}_{ijt}^{k} - {D}_{jt}^{k} {δ}^{k} ⌋ \leq {D}_{jti}^{k} {y}_{j}^{k} \qquad ∀ j ∈ W , t ∈ T , k ∈ M$$

The next equation below specifies the weekly prorate at the DC/item level, which is as follows:

$$⌊ {\sum }_{K ∈ M} {\sum }_{t ∈ T} {x}_{ijt}^{k} - {\sum }_{t ∈ T} {D}_{jt}^{k} {δ}^{k} ⌋ \leq {D}_{jt}^{k} {δ}_{j}^{k} \qquad ∀ j ∈ W , ∀ k ∈ W$$

In some embodiments, the below equation determines the day-of-week (DOW)/item level demand prorate, which is as follows:

$$⌊ {\sum }_{K ∈ M} {\sum }_{I ∈ S} {x}_{ijt}^{k} - {\sum }_{K ∈ M} {D}_{jt}^{k} {δ}^{k} ⌋ \leq {\sum }_{k ∈ M} {D}_{jt}^{k} {θ}_{jt} \qquad ∀ j ∈ W , ∀ t ∈ T$$

In other examples, the weekly level prorate for each DC or other recipient is set by the following equation:

$$\begin{matrix}⌊ {\sum }_{K ∈ M} {\sum }_{t ∈ T} {\sum }_{I ∈ S} {x}_{ijt}^{k} - {\sum }_{K ∈ M} {\sum }_{t ∈ T} {D}_{jt}^{k} ⌋ \leq {\sum }_{k ∈ M} {\sum }_{t ∈ T} {D}_{jt}^{k} {𝒯}_{j} & ∀\end{matrix} j ∈ W$$

In some examples, the variable

$${z}_{i}^{k}$$

is non-negative variable which indicates the number of extra cases shipped from the supplier i for each item k. The variable uᵢⱼₜ is the number of trailers from supplier i to a DC or other recipient j on a selected day t. The variable vᵢⱼₜ is the LTL quantity in lbs. from supplier i to the DC or other recipient j on the selected day t. The MILP optimization model(s) 146 cover all DCs, suppliers, and perishable items at the daily level, and addresses three key challenges through a multi-component objective function.

In other non-limiting embodiments, the objective function is defined as follows:

$$Obj \text{:} Min ( A + B + C )$$

In this example, the first component of the multi-component objective function is the delivery cost for the planning horizon, where:

$$A = {\sum }_{i ∈ 𝒮} {\sum }_{j ∈ W} {\sum }_{k ∈ M} {\sum }_{t ⊆ 𝒯} ( {α}_{i}^{k} + {β}_{ij} ) {x}_{ijt}^{k} {ρ}^{k}$$

Overage cost

$$( {α}_{i}^{k} )$$

and shipping cost (βᵢⱼ) are optionally measured in pounds, while the average case weight (ρ^{k}) remains constant all suppliers. There is a risk of incurring higher delivery costs due to inefficient transportation plans including partial pallets and/or excessive utilization of LTL trailers. The second component of the multi-component objective function is the risk of increasing shipping costs by excessive numbers of LTL quantity, where:

$$B = {\sum }_{i ∈ 𝒮} {\sum }_{j ∈ 𝒲} {\sum }_{t ⊆ 𝒯} λ {v}_{ijt}$$

In still other embodiments, there are no restrictions placed on the daily shipments from each supplier to each distribution center (DC) in terms of the number of trailers used. However, if there are excessive numbers of partially or empty loaded trailers within the planning horizon, shipping costs will rise for that supplier. This results in increased replenishment costs in the future. It is assumed that the violation cost (λ) is the same for all suppliers, but this value can be adjusted to simulate various supplier behaviors.

The third component of the multi-objective function is the item shrinkages and throws, where:

$$C = {\sum }_{i ∈ 𝒮} {\sum }_{k ∈ ℳ} {θ}_{1} {y}_{i}^{k} + {\sum }_{i ∈ 𝒮} {\sum }_{k ∈ ℳ} {θ}_{2} {z}_{i}^{k}$$

The perishable item supply process is a time-consuming and rigorous procedure which can make future item supply unpredictable. Perishable items, such as meat products, also have a short shelf life. As a result, producers cannot easily increase or decrease their output, often leading to a mismatch between negotiated supply and Sam's demand. To address this issue, the system allocates the supply precisely to the units that require it. To minimize the amount of shrinkage or throwaway quantity

$$( {y}_{i}^{k} ) ,$$

we assign a high penalty

$$( {θ}_{i}^{k} ) .$$

This penalty encourages the minimization of waste and helps to ensure that the quantity of discarded products is reduced to zero.

In some examples, the one or more MILP optimization model(s) 146 utilized by the replenishment and merchant manager 140 are subjected constraints. One set of constraints is that the total orders must equal the total supply.

$${\sum }_{j ∈ 𝒲} {\sum }_{t ∈ 𝒯} {x}_{ijt}^{k} \geq {U}_{i}^{k} - {y}_{i}^{k}$$

The above equation ensures that the total orders placed

$$( {\sum }_{j ∈ 𝒲} {\sum }_{t ∈ 𝒯} {x}_{ijt}^{k} )$$

is greater than the total supply

$$( {U}_{i}^{k} )$$

in net of shrinkage/throw quantity

$$( {y}_{i}^{k} ) .$$

With the delivery cost component in the objective function being minimized, total orders are placed as close to the supply as possible. Another exemplary equation for total orders is as follows:

$${\sum }_{j ∈ 𝒲} {\sum }_{t ∈ 𝒯} {x}_{ijt}^{k} \leq {U}_{i}^{k} + {z}_{i}^{k}$$

The above equation guarantees even if the LTL penalty term is introduced in the objective function, the number of orders are not compromised to fulfill the truck load.

A second set of constraints are employed, in some examples, to dynamically adjust the daily order based on the total demand/supply imbalance, within specified upper and lower bound, with the following two equations:

$${\sum }_{I ∈ 𝒮} {x}_{ijt}^{k} \leq {D}_{j 𝓉}^{k} * ( 1 + Max ( 0 , {δ}^{k} ) + \frac{γ - 1}{{δ}^{k}} )$$

$${\sum }_{I ∈ 𝒮} {x}_{ijt}^{k} \geq {D}_{j 𝓉}^{k} * ( 1 + Min ( 0 , {δ}^{k} ) * \frac{η - 1}{{δ}^{k}} )$$

This approach involves a comprehensive network-level pro-rating system that optimizes supply and breakdown to the DC/item level. When the total supply does not match the total demand, daily orders need to be adjusted from the projected demand

$$( {D}_{j 𝓉}^{k} )$$

accordingly to align with the supply. The upper (γ) and lower (η) bound is set to ensure that DC capacity or safety stock is not exceeded, and to distribute orders throughout the planning horizon. The gap (δ^{k}) refers to the total difference between demand and supply. If it is not zero, one of the constraints above are triggered to put a limit on order fluctuation.

In other examples, a third set of constraints include assortment set up constraints. The following two equations are utilized for the third set of constraints:

$${\sum }_{j ∈ 𝒲} {\sum }_{t ∈ 𝒯} {x}_{ijt}^{k} \leq {a}_{i}^{k}$$

$${\sum }_{k ∈ ℳ} {\sum }_{t ∈ 𝒯} {x}_{ijt}^{k} \leq {b}_{ij}$$

In some examples, suppliers have their own constraints to consider. Each supplier has a limited selection of perishable items or other perishable items that the supplier can provide

$$( {a}_{i}^{k} ) ,$$

meaning not an suppliers can provide all items. In addition, there are shipment constraints (bᵢⱼ) that must be considered. For instance, three smaller suppliers may only be able to serve specific DCs. In other examples, the total daily cases from each supplier to each DC is defined as:

$${\sum }_{k ∈ ℳ} {x}_{ijt}^{k} = T * {u}_{ijt} - {v}_{ijt}$$

This equation works with the second term in the objective function to minimize the LTL occurrence.

In the replenishment process, numerous exceptions and unique use cases exist. One such exception involves maintaining the original demand for specific DCs and items, regardless of whether the overall system supply falls short of the demand. For instance, during events like the fourth of July, it is desirable to avoid compromising the demand for burgers in Texas. A subset of W is denoted as W₁⊆W and a subset of B is denoted as B₁⊆B. In some embodiments, the equation for daily DC/item demand adjustment is modified as follows:

$${\sum }_{I ∈ M} {x}_{ijt}^{k} {D}_{j 𝓉}^{k} {δ}^{k} \leq max ( 0 , {D}_{j 𝓉}^{k} {γ}_{j}^{k} ) ∀ j ∈ W , t ∈ T , k ∈ {B}_{w}$$

In other examples, a redefined equation for weekly item demand adjustment is as follows:

$${\sum }_{t ∈ T} {\sum }_{I ∈ S} {x}_{ijt}^{k} - {\sum }_{t ∈ T} {D}_{j 𝓉}^{k} {δ}^{k} \leq max ( 0 , {\sum }_{t ∈ T} {D}_{j 𝓉}^{k} {σ}_{j}^{k} ) ∀ j ∈ {W}_{i} , k ∈ {B}_{w}$$

Another special case involves smaller suppliers. Often, the quantity they offer is insufficient for a single truck to deliver to one DC, which typically triggers high LTL costs. As a result, these suppliers usually consolidate shipments for different DCs.

The subset of suppliers, in some examples, is denoted as S₂⊆S and combined DCs as a subset of DC Wₛ⊆W.

$${\sum }_{S ∈ {S}_{2}} {\sum }_{W ∈ {W}_{s}} {x}_{ijt}^{k} {ρ}^{k} \leq {mTy}_{ijt} ∀ s ∈ {S}_{2} , j ∈ {W}_{i}$$

The model is versatile to handle other unique scenarios, such as enforcing mandatory delivery dates, and managing order proportions for specific suppliers, DCs, and items. As the number of decision variables increases and the variables are of integer type, problem-solving becomes time-consuming. In some instances, a ten hour runtime failed to yield a satisfactory solution. Thus, the system aims to reduce the occurrence of partial pallets rather than the total item quantity involved in partial pallets. Model relaxation and decomposition is implemented along with heuristic pallet options generation mechanism. This approach enables the system to manage the complexity of the problem more effectively and efficiently.

In some embodiments, the system assumes the initial cost optimization model for the supplier breakout solution serves as an estimate during model relaxation and decomposition. The pallet optimization model takes the estimate to fine-tune and minimize the occurrence of partial pallets. In this context, whether the initial solution is an integer or not does not significantly impact the outcome.

Therefore, the decision variable

$${x}_{ijt}^{k}$$

is relaxed from non-negative integers to non-negative reals. However, the type of γᵢⱼₜ is retained to keep the balance between runtime and accuracy. The results show that this relaxation can reduce the runtime from four hours to just a few minutes, enabling significant reduction in processor and memory usage during runtime. Following this, the initial result from the cost optimization model is used to construct another optimization model aimed at reducing the occurrence of partial pallets. In this manner, the system decomposes a complex problem into two more manageable subproblems.

After obtaining the supplier breakout result

$${x}_{ij 𝓉}^{- k}$$

from cost optimization, the pallet set up rules for each item are applied. This involves determining the number of cases fₖ that can fit on a full pallet for each item k. Subsequently, a search is conducted for the closest full options for each item k, supplier I, distribution center j, and day t. From the initial solution, a lower bound option

$${l}_{ijt}^{k}$$

and an upper bound option

$${h}_{ijt}^{k}$$

is established for the final breakout solution. The lower bound option is calculated as follows:

$${l}_{ijt}^{k} = [ {x}_{ijt}^{k} / {f}_{k} ] * {f}_{k}$$

The upper bound option is calculated as follows:

$${h}_{ijt}^{k} = ( [ {x}_{ij 𝓉}^{- k} / {f}_{k} ] + 1 ) * {f}_{k} ∀ i ∈ 𝒮 , j ∈ W , t ∈ T , k ∈ M$$

Any quantity that lies between the lower bound option

$${l}_{ijt}^{k}$$

and the upper bound option

$${h}_{ijt}^{k}$$

that is not equal to them is considered as a partial pallet occurrence for item k.

The objective function minimizes the total partial pallet occurrences. The pallet optimization model, in some embodiments, is defined in the equation below.

$$Min {\sum }_{i ∈ 𝒮} {\sum }_{j ∈ W} {\sum }_{k ∈ M} {\sum }_{t ∈ T} {p}_{ijt}^{k}$$

The pallet optimization model constraints define the range for partial pallet quantity for an item from a supplier to a DC on a specific day. The constraints ensure that lower bound full pallet, partial pallet, and upper bound full pallet is mutually exclusive for item k from supplier i to DC j on day t. The constraints prevent the increase in the number of trailers from supplier i to DC j on day t. The model allows flexibility in daily DC/item/DOW/DC level prorate.

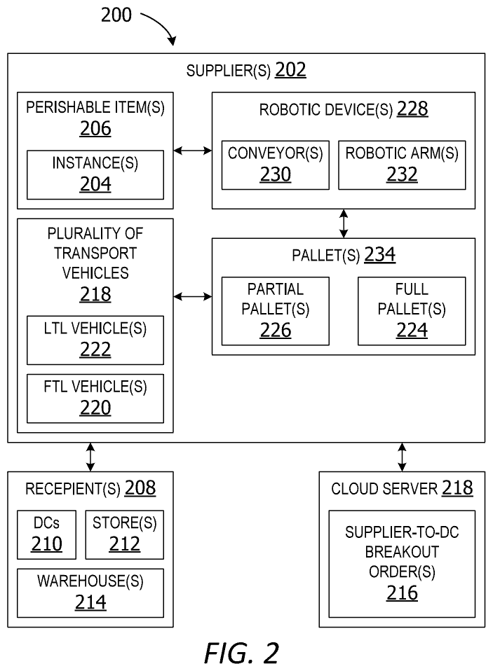

FIG. 2 is an exemplary block diagram illustrating a system 200 for dynamic perishable item replenishment while minimizing transportation costs, less than truckloads (LTLs) and partial pallet occurrences. LTL may also be referred to as less than load and/or less than full truckload. One or more supplier(s) 202 provide one or more instance(s) 204 of one or more perishable item(s) 206 to one or more recipient(s) 208, such as one or more DCs 210, store(s) 212, and/or warehouse(s) 214. The supplier(s) 202 are selected from a plurality of suppliers capable of providing instances of the one or more perishable item(s) 206 within one or more supplier-to-DC breakout order(s) 216. The supplier-to-DC breakout order(s) 216 include daily breakout orders and/or weekly breakout orders.

Daily breakout orders enable flexibility and customization of replenishment orders such that different amounts of the same item may be received on different days to meet changing daily demand levels at stores and/or DCs. For example, a store may have demand for the same amount of ground beef every day but only require half as many instances of ribs on Monday than on Friday.

The perishable item(s) 206 are transported from the supplier(s) location(s) to the recipient(s) location(s) via a plurality of transport vehicles 218. The assignments generated by the replenishment and merchant manager maximizes full truck load (FTL) vehicle(s) 220 for transporting the maximum number of pallets in full trucks while minimizing the number of LTL vehicle(s) 222. This enables the fewest number of transportation vehicles to be used to transport the instance(s) 204 of the perishable item(s) 206 to the recipient(s) 208.

In other embodiments, the cloud server 118 provides pallet build parameters to the supplier(s) 202. The pallet build parameters are used to inform pallet building, such that full pallet(s) 224 are maximized and partial pallet(s) 226 are minimized. A partial pallet is a pallet of items or cases of items on a wooden pallet base which does not contain the maximum number of items or cases on the pallet. In other words, a partial pallet is a pallet of items which is capable of holding additional items or cases of items.

In some embodiments, one or more robotic device(s) 228 are utilized to autonomously build the pallet(s) 234 and/or autonomously load the pallet(s) 234 onto one or more transport vehicles in the plurality of transport vehicles 218. The robotic device(s) 228 includes devices, such as, but not limited to, the robotic devices 138 in FIG. 1. The robotic device(s) 228 in some embodiments includes a set of one or more conveyor(s) 230 for moving pallets from one location to another. In other embodiments, the robotic device(s) 228 includes one or more robotic arm(s) 232 or other robotic devices for lifting, carrying, wrapping, boxing, or otherwise moving one or more items.

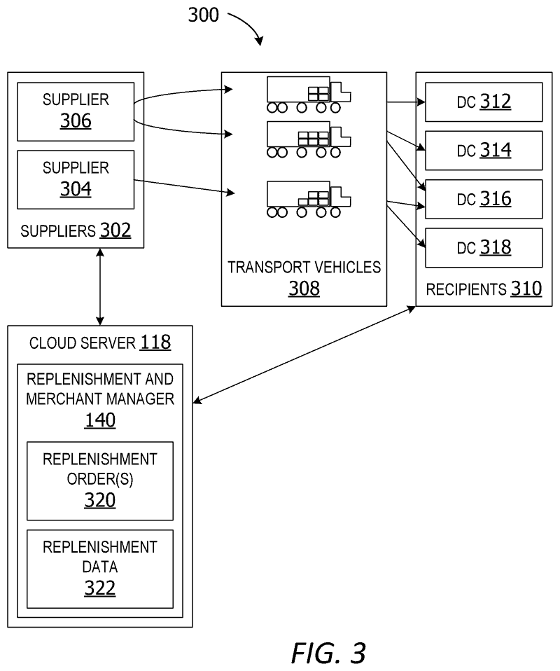

Turning now to FIG. 3, an exemplary block diagram illustrating a system 300 for replenishment of perishable items using dynamic replenishment data is shown. In this example, a set of suppliers 302 of one or more perishable items, such as, but not limited to, the supplier(s) 202 in FIG. 2. The suppliers 302 includes a first supplier 304 and a second supplier 306. However, the embodiments are not limited to two suppliers. In other embodiments, the suppliers 302 includes three or more suppliers.

A plurality of transport vehicles 308 are utilized to transport instances of perishable items from the suppliers 302 to one or more recipients 310. The transport vehicles 308 include trucks, trailers, vans, or any other type of transport vehicle, such as, but not limited to, the transport vehicles 136 in FIG. 1. In this example, the transport vehicles 308 are transporting pallets of items.

The recipients 310 is a set of one or more recipients of pallets of items from the suppliers, such as, but not limited to, the recipient(s) 208 in FIG. 2. The recipients 310 in this example includes four DCs, a DC 312, a DC 314, a DC 316, and a DC 318. However, the embodiments are not limited to four DCs. In other examples, the recipients include a single DC, two DCs, three DCs, as well as five or more DCs.

The recipients 310 provide replenishment data to the replenishment and merchant manager 140 on the cloud server via a network. The replenishment and merchant manager 140 uses the real-time replenishment data to generate replenishment order(s) 320 requesting replenishment of items from the suppliers. The replenishment data 322 includes daily demand data of the DCs, current inventory of the DCs, capacity of the DCs, etc. The replenishment order(s) 320 include request for specified numbers of instances of selected perishable items from selected suppliers based on the replenishment data, supplier constraints, and other available data.

FIG. 4 is an exemplary block diagram illustrating a replenishment and merchant manager 140 having a MILP cost minimization model 416 and a MILP pallet minimization model 424. In some examples, the replenishment and merchant manager 140 receives input(s) 402 from a data storage device, a cloud storage, or other data source. The input(s) 402 include replenishment data 403, such as, but not limited to, forecast daily demand 404, constraint(s) 406, current inventory 408, and/or other data 409. Other data 409 optionally incudes supply data, demand data, shipping cost(s), item case weight for each case containing instances of each item, pallet setting data, etc.

The daily demand 404 includes item level 410 daily demand forecasts, store level 412 daily demand forecasts, and/or DC level 414 daily demand forecasts. Item level 410 daily demand forecasts includes daily demand for items, such as meat category items or dairy category items. Store level 412 daily demand refers to demand for a specific item at each store. The DC level 414 demand refers to demand for replenishment of items at each DC.

The constraint(s) 406 include one or more rules, limitations, agreements, parameters, or other guidelines used to negotiate supplier provision of perishable items to DCs. The constraint(s) 406 include supplier specific constraints, recipient specific constraints, as well as user-configurable constraints.

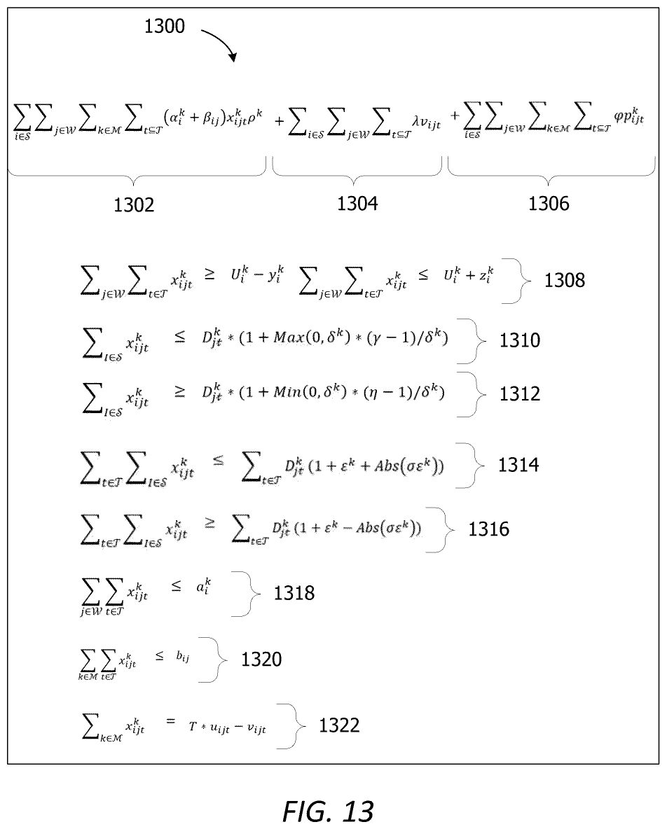

In some embodiments, a MILP cost optimization model 416 identifies a subset 418 of available transport vehicles 420 which can be assigned to transport all instances of the perishable items requested from the suppliers in compliance with the supplier constraints. The MILP truck optimization model 416 is a model utilizing a MILP-based algorithm to optimize transport vehicle usage, such as, but not limited to, the MILP optimization model(s) 146 in FIG. 1. The subset 418 of vehicles is the minimum number 422 of vehicles which can accommodate all the pallets of perishable items from each supplier to each DC. The MILP truck optimization model, which can also be referred to as MILP cost optimization is calculated as minimum delivery cost plus minimum LTL plus opportunity costs as shown in FIG. 13 below.

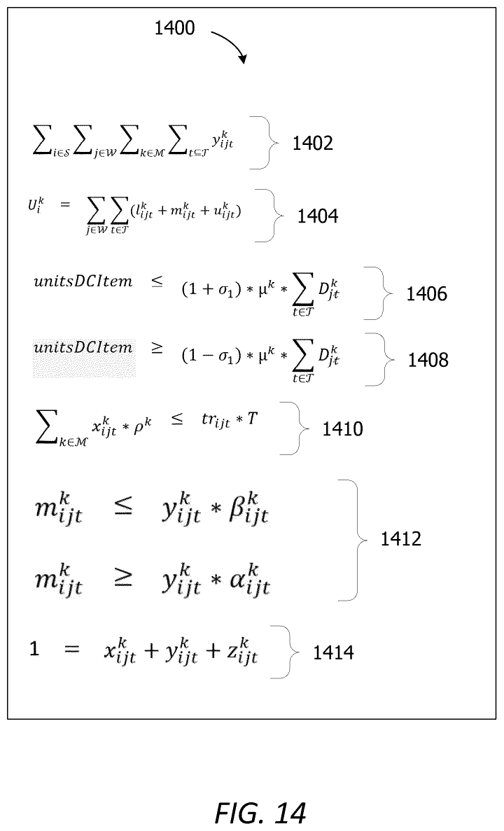

In other examples, a MILP pallet optimization model 424 analyzes the input(s) 402 with any other available real-time replenishment data to generate pallet build parameters 428. The MILP pallet optimization model 424 is a model utilizing a MILP-based algorithm to optimize pallet build/packaging of items or cases of items for shipment, such as, but not limited to, the MILP optimization model(s) 146 in FIG. 1. The pallet build parameters 428 include instructions 426 for building pallets while minimizing the number of partial pallets of items provided by each supplier and/or reducing the number of partial pallets on each transport vehicle. In some examples, the MILP pallet optimization model 424 performs a series of MILP-based calculations to identify optimal pallet builds minimizing the number of partial pallets used to ship items, such as, but not limited to, the equations as shown in FIG. 14 below.

A results component 430 is a software component for generating a replenishment result 432. The result 432 includes assignment(s) 434 of transport vehicles for transporting perishable items from suppliers and/or the parameters. In other examples, the result 432 also includes daily breakout order(s) 438. The daily breakout order(s) 438 can include multi-supplier splits, such as splitting orders for replenishment of a perishable item from three or more suppliers. A supplier split refers to requesting a portion of a replenishment order for a single item from two or more suppliers rather than requesting all the instances of the same item in the replenishment order from the same supplier.

In some embodiments, the replenishment and merchant manager obtains daily demand forecast data from a centralized forecasting system (CDF). The CDF generates a category-level demand forecast, which is then transformed into a club-level forecast by event-driven forecasting (EDF). Using real-time inventory data from an enterprise inventory (EI), the Replenishment team generates a DC-level forecast. The optimization model utilizes the DC-level forecast as one input, while a user provides additional inputs such as negotiated supply book numbers, assortment constraints, and cost information. The optimization model then generates optimal supplier breakout orders, which are reviewed by a user before being incorporated into an order management system (OMS).

FIG. 5 is an exemplary bloc diagram illustrating a replenishment and merchant manager 140 including MILP optimization models for optimizing replenishment of perishable items using real-time supply and demand data. The replenishment and merchant manager 140 receives input data 502 and configurable constraints 504. The input data 502 includes input replenishment data, such as, but not limited to, the replenishment data 128 in FIG. 1, the replenishment data 322 in FIG. 3, and/or the input(s) 402 in FIG. 4. In this example, the input data 502 includes weekly supply, daily demand, supplier shipping cost, supplier overage cost, and item case weight. The case weight can vary depending on the type of item.

The configurable constraints 504 includes supplier constraints and/or other user-configurable parameters, such as, but not limited to, the constraints data 132 in FIG. 1 and/or the constraint(s) 406 in FIG. 4. In this example, the configurable constraints 504 incudes transport vehicle (truck) load capacity, LTL violation cost, daily demand pro rate range, weekly demand pro rate range, and/or supply upper bound.

In some embodiments, data validation 506 is performed to validate the input data 502 received from the input data source, such as, but not limited to, a data storage device, a cloud storage, cloud server, or other source of the replenishment data. In this example, data validation 506 includes error handling.

The replenishment and merchant manager ensures that it adheres to the configurable constraints 504 and any other applicable rules. In some examples, the replenishment model maintains a balance between demand and supply, respects assortment constraints, adheres to supplier requirements, DC requirements, and/or item-specific requirements, align to supply number requirements, as well as taking exceptions.

A MILP truck optimization model performs a cost optimization to minimize shipping costs, overage costs and LTL violation costs at 508. The truck optimization model is a model, such as, but not limited to, the MILP truck optimization model 416 in FIG. 4.

Shipping costs refers to costs associated with shipping items, such as the costs for building pallets, costs for transport vehicles, etc. The overage costs refer to loss or expense resulting from producing or ordering too much inventory. It can be calculated as the unit cost minus any salvage value of the surplus items. The overage costs include the costs of item throws. Holding costs associated with obtaining too many instances of a perishable item, such that more perishable items are on-hand than can be sold or used as ingredients in other fresh products, refers to the expense incurred in storing unsold inventory. The LTL violation costs refer to costs associated with transport vehicles which are not filled to capacity in accordance with agreements, constraints or other requirements.

In some embodiments, the cost optimization model minimizes system delivery costs and maximizes truck utilization by employing a multi-objective function. The cost optimization model generates an initial solution for daily breakout orders for each item, considering the specific needs and requirements of each DC or other recipient, such as the initial result 510.

The initial result 510 includes an initial supplier-to-DC breakout order and/or truck assignment 512 identifying a minimized number of transport vehicles for shipping the items. The truck assignment 512 and/or initial result 510 are provided to a MILP pallet optimization model, such as, but not limited to, the MILP pallet optimization model 424 in FIG. 1.

Item pallet setup rules 514 includes user-configurable rules and parameters for building pallets. The rules are specific to each supplier and/or specific to each item. For example, the rules may require a different number of cases of ground beef for a complete pallet than the number of cases of turkeys required for a complete pallet. The number of cases that fit within a complete pallet vary depending on the size and dimensions of the items and/or the cases enclosing the items.

An item pallet options generator 516 provides options for building pallets/packaging items from each supplier based on the supplier-specific and item-specific rules. The MILP pallet optimization model performs pallet optimization to minimize partial pallet occurrences at 518. The replenishment and merchant manager 140 generates one or more result(s) 520, including supplier-to-DC breakout at 522. The supplier-to-DC breakout is a per-supplier and per-item specific daily breakout orders for replenishment of a given item to a specific set of DCs. In this manner, the system enables replenishment cost savings, reduced LTL, reduced transport vehicle (truck) utilization, better coordination between suppliers and DCs, as well as increased utilization of full pallets.

Referring now to FIG. 6, an exemplary flow chart illustrating operation of the computing device to dynamically replenish perishable items is shown. The process 600 shown in FIG. 6 is performed by a replenishment and merchant manager component, executing on a computing device, such as the computing device 102 or the user device 116 in FIG. 1.

The process begins by obtaining dynamic replenishment data at 602. The replenishment data is data such as, but not limited to, the replenishment data 128 in FIG. 1, the replenishment data 322 in FIG. 3, the input(s) 402 in FIG. 4, and/or the input data 502 in FIG. 5. The replenishment and merchant manager calculates a minimized number of transport vehicles for minimizing truck utilization and minimizing transportation cost using a MILP model at 604. In some examples, the MILP model is a model such as, but not limited to, the MILP optimization model(s) 146 in FIG. 1 and/or the MILP truck optimization model 416 in FIG. 4.

The replenishment and merchant manager assigns perishable item instances to a subset of transport vehicles while minimizing LTL occurrences at 606. The subset of transport vehicles includes vehicles, such as, but not limited to, the transport vehicles 136 in FIG. 1 and/or the transport vehicles 308 in FIG. 3. The replenishment and merchant manager generates pallet build parameters for reducing occurrences of partial pallets using a second MILP model at 608. The second MILP model is a model for optimizing pallet build, such as, but not limited to, the MILP optimization model(s) 146 in FIG. 1 and/or the MILP pallet optimization model 424 in FIG. 4. The replenishment and merchant manager generates a result using the assignments and parameters conforming to supply, demand and supplier constraints at 610. The result is a replenishment result, such as, but not limited to, the result(s) 124 in FIG. 1, the result 432 in FIG. 4, and/or the result(s) 520 in FIG. 5. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to automatically build and load pallets using optimized pallet build parameters and transport vehicle assignments for dynamic perishable item replenishment. The process 700 shown in FIG. 7 is performed by a replenishment and merchant manager component, executing on a computing device, such as the computing device 102 or the user device 116 in FIG. 1.

The process begins by receiving instructions from a replenishment and merchant manager at 702. The instructions include pallet build instructions, such as, but not limited to, the instructions 426 in FIG. 4. One or more pallet(s) are built at 704. In this example, the pallets are built by one or more robotic devices, such as, but not limited to, the robotic devices 138 in FIG. 1 and/or the robotic device(s) 228 in FIG. 2. The pallet(s) are loaded onto transport vehicles at 706. In this example, the pallets are autonomously loaded by robotic devices, such as, but not limited to, the robotic devices 138 in FIG. 1 and/or the robotic device(s) 228 in FIG. 2. A determination is made whether loading is complete at 708. If not, the process iteratively executes operations 702 through 708 until all pallets are built and loaded at 708. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

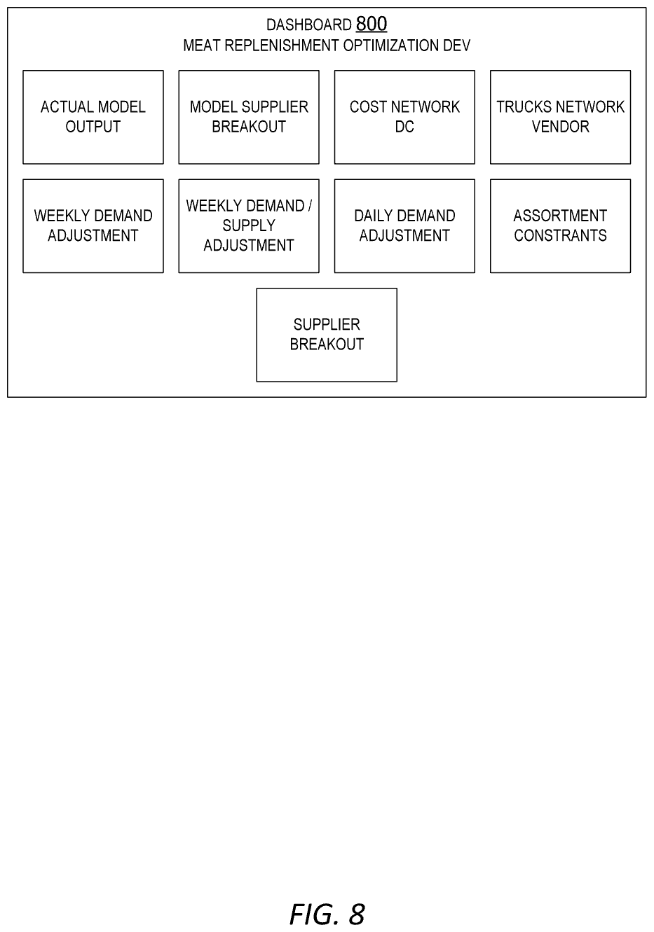

FIG. 8 is an exemplary diagram illustrating a perishable item replenishment optimization results dashboard 800. The dashboard 800 is a UI results page consolidating replenishment optimization results, such as, but not limited to, the dashboard 122 in FIG. 1. In this non-limiting example, the dashboard includes information such as, but not limited to, actual model output, model supplier breakout, cost network DC, trucks network vendor, weekly demand adjustment, weekly demand/supply adjustment, daily demand adjustment, assortment constraints, and/or supplier breakout data.

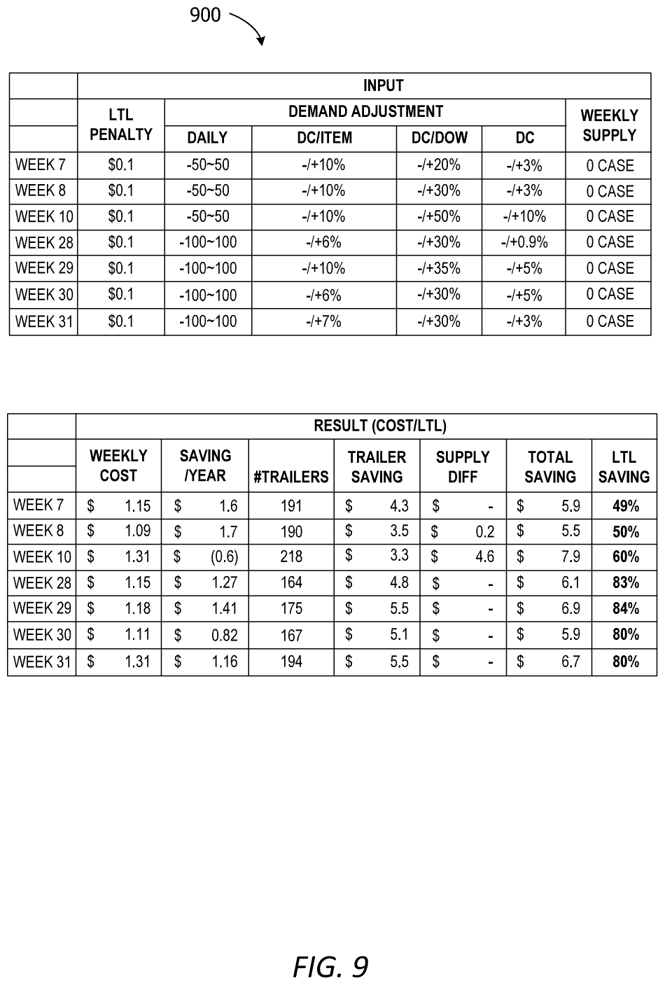

FIG. 9 is an exemplary diagram illustrating result summaries 900 for perishable item replenishment. In this non-limiting example, the results include input data and cost savings as a result of the optimizations. In this example, the savings include savings due to reductions in LTL shipments as well as cost savings attributable to utilization of the MILP based models for optimizing pallet build and transport vehicle assignments.

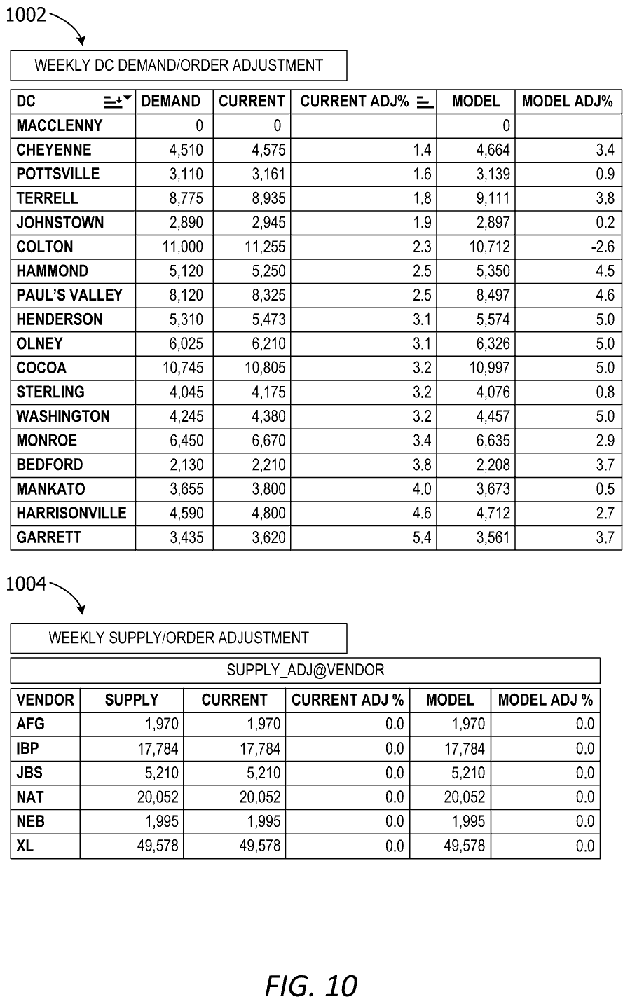

FIG. 10 is an exemplary diagram illustrating dynamic weekly demand order adjustment 1002 and weekly supply order adjustment 1004. Supply and demand order adjustments are performed dynamically on a weekly basis to adjust perishable item orders based on the current supplies of perishable items available from suppliers as well as demand from stores and/or DCs for the perishable items.

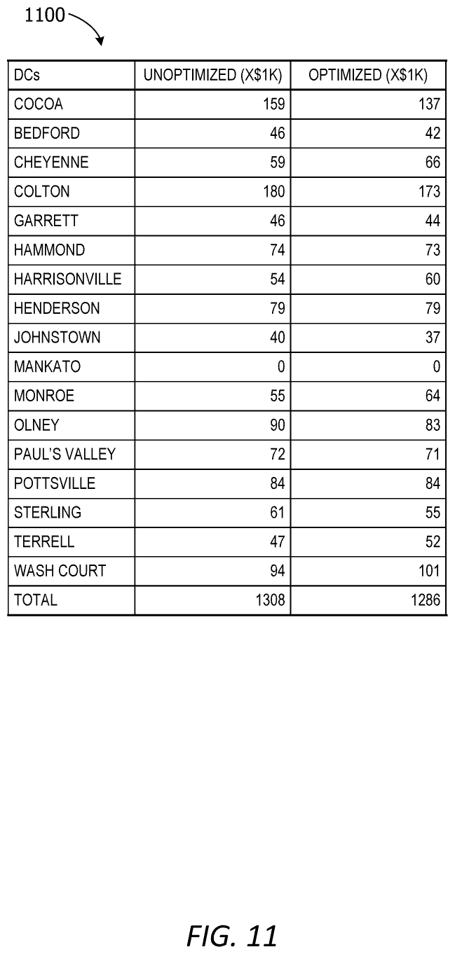

FIG. 11 is an exemplary table 1100 illustrating delivery costs with transport resource utilization optimization using MILP based optimization models. As shown in table 1100, optimization of perishable item replenishment transport vehicle assignments and pallet build to reduce partial pallets and LTL loads results in reduction in the number of transport vehicles utilized to delivery items to DCs.

The MILP optimization model(s) of the replenishment and merchant manager system significantly improves delivery costs, as shown in table 1100. In this example, the MILP optimization model(s) are run with objective function minimizing on the delivery cost, resulting in a cost savings of $20K compared to the current model, equating to a $1.1 M cost savings per year. Table 1100 displays the delivery costs for the distribution centers.

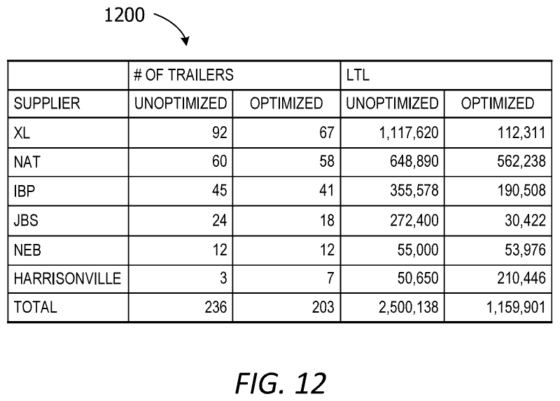

FIG. 12 is an exemplary table 1200 illustrating transport vehicle utilization with transport resource utilization optimization using MILP based optimization models. As shown in table 1200, the dynamic perishable item replenishment system results in reduction of LTL loads for improved transport resource utilization.

The MILP optimization model(s) of the replenishment and merchant manager system considers the LTL quantity and generates a schedule that minimizes the usage of trucks, in addition to providing cost savings. The table 1200 illustrates the trailer usage and LTL occurrence across multiple suppliers. As shown in FIG. 12, the replenishment and merchant manager provides significant improvement reducing LTL occurrence by 1.4 million pounds, translating to significant opportunity cost savings.

Referring now to FIG. 13, an exemplary illustration of MILP cost optimization formulations 1300 for truck optimization is shown. In this example, multi-objectives are calculated which include minimum delivery cost 1302 added to minimum LTL 1304 and opportunity cost 1306. The MILP truck optimization model accounts for weekly order equals to supply total for each SKU and each supplier 1308, daily demand adjustment using upper and lower bounds 1310, weekly demand adjustment with lower and upper bounds 1312, assortment constraints for suppliers 1314, assortment constraints for recipients (DCs) 1316, order evaluated by trailers and LTL 1318, and other special constraints, such as supplier constraints, DC constraints, shipping day constraints, and item constraints 1320. Other exceptions 1322 may also be considered in accordance with the formulations shown in FIG. 13.

FIG. 14 is an exemplary illustration of MILP pallet optimization formulations 1400 for minimizing partial pallets. In this example, a minimizing partial pallet 1402 formulation is utilized. The MILP pallet optimization model includes formulations for weekly order equals to supply total for each SKU and each supplier 1404, DC demand adjustment within lower and upper bounds 1406, and DC item demand adjustment within lower and upper bounds 1408. Transport vehicle numbers cannot be increased 1410, they can only be decreased or reduced from the total number of available transport vehicles. Partial pallets must be between the lower full pallet option and upper full pallet option 1412, and partial pallet and full pallet are mutually exclusive 1414. In other words, a pallet is a partial pallet or a full pallet. A pallet cannot be classified as both.

### Additional Examples

In some examples, the system optimizes replenishment efficiency in multi-supplier and multi-purpose item assortment. The system provides an optimization of perishable item replenishment from two or more suppliers to one or more DCs using dynamic replenishment data and user-configurable constraints. The system results are used to improve working efficiency, minimize delivery cost, reduce opportunity cost, minimize the number of partial pallets on delivery trucks, and optimize truck utilization for item replenishment process by optimally assigning the number of cases delivered for each SKU from each supplier to each DC on a daily level.

The system generates cost savings across several areas. In some examples, the system automates and streamlines an item replenishment process, such as meat replenishment, which currently involves substantial manual work by the demand planning, replenishment, and merchandise teams. By utilizing the MILP optimization model(s), the run time of the computing system is reduced to just a few hours. This leads to significant reduction in costs and savings due to reduced time and labor consumed during the replenishment process.

In some examples, the system leverages data-driven insights and real-time market information to provide an optimal DC breakout solution for each item among multiple suppliers, helping merchants make more informed decisions. It minimizes the delivery cost of current planning horizon, item shrinkage and throw, and helps to reduce the future shipping cost. It also improves the workflow efficiency and automation by reducing half a week work across multiple teams to just a few hours. The optimal solution merges into the current order management system (OMS) system, reducing replenishment cost, and improving overall system performance and enhancing operational efficiency.

Other embodiments incorporate upper and lower bounds to maintain compliance with DC capacity limitations and item level safety stock requirements while adjusting orders to accommodate supply availability. Moving forward, the model's next phase involves integrating real-time inventory data with order forecasting to generate a more dynamic projection of future inventory levels. Additional constraints are introduced to align with DC capacity and item safety stock levels.

Alternatively, or in addition to the other examples described herein, examples include any combination of the following:
build, by a set of robotic pallet building devices, each pallet in the plurality of pallets in accordance with the optimized pallet build parameters;
load each pallet in the plurality of pallets onto each vehicle in the subset of vehicles for delivery to a destination by a set of robotic loading devices and a set of conveyors;
generate, by the MILP cost minimization model, optimized transport vehicle assignments assigning a plurality of pallets to each transport vehicle in the subset of vehicles, the optimized transport vehicle assignments customized for each supplier and each transport vehicle on a daily basis minimizing a number of less than truckload (LTL) transport vehicles utilized to transport perishable items from a supplier to a recipient;
assign a number of cases of perishable items delivered for each unique item identifier (UID) from each supplier to each recipient per day using a minimum number of LTL transport vehicles and a minimum number of partial pallets for each UID;
adjust daily order amounts of perishable items dynamically based on total demand and supply imbalance specified within an upper bound and a lower bound associated with recipient capacity;
update purchase orders (POs) for a supplier in real-time based on dynamic changes in supply or demand for a selected perishable item;
identifying three or more suppliers to provide replenishment of the perishable item;
allocating three or more transport vehicles for transport of the instances of the perishable item to the plurality of recipients, wherein the replenishment result comprises assignments of pallets containing instances of the perishable item to each vehicle in the three or more transport vehicles while minimizing a number of LTL vehicle occurrences and reducing a number of partial pallet occurrences;
obtaining dynamic replenishment data for a perishable item available from a plurality of suppliers for delivery to a plurality of recipients, the dynamic replenishment data comprising forecast daily demand data for the perishable item, current inventory data for the perishable item, and supplier constraint data;
calculating, by a MILP truck (shipping cost) minimization model using the dynamic replenishment data, a minimized number of transport vehicles for transporting requested instances of the perishable item from the plurality of suppliers to the plurality of recipients in conformance with the supplier constraints;
assigning the instances of the perishable item requested from the plurality of suppliers to a subset of vehicles in a plurality of available transport vehicles for transporting the instances of the perishable item from each supplier to each recipient in the plurality of recipients, wherein the subset of vehicles comprises the minimized number of transport vehicles capable of delivering all the instances of the perishable item to the plurality of recipients;
generating, by a MILP pallet minimization model using the dynamic replenishment data, pallet build parameters customized for each supplier in the plurality of suppliers comprising instructions for building a plurality of pallets for transporting the instances of the perishable item requested from each supplier using a minimum number of partial pallets;
generating a replenishment result comprising the optimized pallet build parameters for building the plurality of pallets with the minimum number of partial pallets and assignments of the plurality of pallets from the plurality of suppliers to the minimized number of transport vehicles for transport of the instances of the perishable item to the plurality of recipients with reduced transportation resource usage;
automatically building, by a set of robotic pallet building devices, each pallet in the plurality of pallets in accordance with the optimized pallet build parameters;
automatically loading each pallet in the plurality of pallets onto each vehicle in the subset of vehicles for delivery to a destination using a set of robotic loading devices and a set of conveyors;
generate, by the MILP cost minimization model, optimized transport vehicle assignments, wherein a pallet are assigned to each transport vehicle in the subset of vehicles, and wherein the optimized transport vehicle assignments customized for each supplier and each transport vehicle on a daily basis minimizing a number of LTL transport vehicles utilized to transport perishable items from a supplier to a recipient;
assigning a number of cases of perishable items delivered for each UID from each supplier to each recipient per day using a minimum number of LTL transport vehicles and a minimum number of partial pallets for each UID;
adjusting daily order amounts of perishable items dynamically based on total demand and supply imbalance specified within an upper bound and a lower bound associated with recipient capacity;
dynamically updating daily POs and weekly POs for a plurality of suppliers in real-time based on dynamic changes in supply of the plurality of suppliers and demand for a selected perishable item from a plurality of distribution centers (DCs);
generating a three-way supplier split for the perishable item, wherein a desired number of instances of the perishable items are requested from three suppliers to provide replenishment of the perishable item;
obtaining dynamic replenishment data for a plurality of perishable items available from a plurality of suppliers for delivery to a plurality of recipients, the dynamic replenishment data comprising forecast daily demand data for the plurality of perishable items, current inventory data for the plurality of perishable items, and user-configurable constraint data;
calculating, by a MILP cost minimization model using the dynamic replenishment data, a minimized number of transport vehicles for transporting requested instances of each perishable item from the plurality of suppliers to the plurality of recipients in conformance with the supplier constraints;
assigning the instances of each perishable item requested from the plurality of suppliers to a subset of vehicles in a plurality of available transport vehicles for transporting the instances of each perishable item from each supplier to each recipient in the plurality of recipients, wherein the subset of vehicles comprises the minimized number of transport vehicles capable of delivering all the instances of the plurality of perishable items to the plurality of recipients;
generating, by a MILP pallet minimization model using the dynamic replenishment data, pallet build parameters customized for each supplier in the plurality of suppliers comprising instructions for building a plurality of pallets for transporting the instances of the plurality of perishable items requested from each supplier using a minimum number of partial pallets;
generating a replenishment result comprising the optimized pallet build parameters for building the plurality of pallets with the minimum number of partial pallets and assignments of the plurality of pallets from the plurality of suppliers to the minimized number of transport vehicles for transport of the instances of each perishable item to the plurality of recipients with reduced transportation resource usage;
building, via a set of robotic pallet building devices, each pallet in the plurality of pallets in accordance with the optimized pallet build parameters;
loading each pallet in the plurality of pallets onto each vehicle in the subset of vehicles for delivery to a destination via a set of robotic loading devices and a set of conveyors;
generating, by the MILP cost minimization model, optimized transport vehicle assignments assigning a plurality of pallets to each transport vehicle in the subset of vehicles, the optimized transport vehicle assignments customized for each supplier and each transport vehicle on a daily basis minimizing a number of LTL transport vehicles utilized to transport perishable items from a supplier to a recipient;
assigning a number of cases of perishable items delivered for each stock keeping unit (SKU) from each supplier to each recipient per day using a minimum number of LTL transport vehicles and a minimum number of partial pallets for each SKU;
adjusting daily order amounts of perishable items dynamically based on total demand and supply imbalance specified within an upper bound and a lower bound associated with capacity of a recipient distribution center (DC); and
dynamically updating weekly POs requesting a plurality of perishable items from a plurality of suppliers in real-time based on dynamic changes in supplier supply of the plurality of perishable items, forecast weekly demand for the plurality of perishable items at a store level, and forecast weekly demand for the plurality of perishable items at a DC level.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4, and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of dynamically replenishing perishable items from suppliers to recipients while minimizing resource usage, the method comprising obtaining dynamic replenishment data for a perishable item available from a plurality of suppliers for delivery to a plurality of recipients, the dynamic replenishment data comprising forecast daily demand data for the perishable item, current inventory data for the perishable item, and supplier constraint data; calculating, by a MILP cost minimization model using the dynamic replenishment data, a minimized number of transport vehicles for transporting requested instances of the perishable item from the plurality of suppliers to the plurality of recipients in conformance with the supplier constraints; assigning the instances of the perishable item requested from the plurality of suppliers to a subset of vehicles in a plurality of available transport vehicles for transporting the instances of the perishable item from each supplier to each recipient in the plurality of recipients, wherein the subset of vehicles comprises the minimized number of transport vehicles capable of delivering all the instances of the perishable item to the plurality of recipients; generating, by a MILP pallet minimization model using the dynamic replenishment data, pallet build parameters customized for each supplier in the plurality of suppliers comprising instructions for building a plurality of pallets for transporting the instances of the perishable item requested from each supplier using a minimum number of partial pallets; and generating a replenishment result comprising the optimized pallet build parameters for building the plurality of pallets with the minimum number of partial pallets and assignments of the plurality of pallets from the plurality of suppliers to the minimized number of transport vehicles for transport of the instances of the perishable item to the plurality of recipients with reduced transportation resource usage.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for perishable item replenishment while minimizing transportation resource usage. For example, the elements illustrated in FIG. 1, FIG. 2, FIG. 3, FIG. 4, and FIG. 5, such as when encoded to perform the operations illustrated in FIG. 6, and FIG. 7, constitute exemplary means for obtaining dynamic replenishment data for a perishable item available from a plurality of suppliers for delivery to a plurality of recipients, the dynamic replenishment data comprising forecast daily demand data for the perishable item, current inventory data for the perishable item, and supplier constraint data; exemplary means for calculating, by a MILP cost minimization model using the dynamic replenishment data, a minimized number of transport vehicles for transporting requested instances of the perishable item from the plurality of suppliers to the plurality of recipients in conformance with the supplier constraints; exemplary means for assigning the instances of the perishable item requested from the plurality of suppliers to a subset of vehicles in a plurality of available transport vehicles for transporting the instances of the perishable item from each supplier to each recipient in the plurality of recipients, wherein the subset of vehicles comprises the minimized number of transport vehicles capable of delivering all the instances of the perishable item to the plurality of recipients; exemplary means for generating, by a MILP pallet minimization model using the dynamic replenishment data, pallet build parameters customized for each supplier in the plurality of suppliers comprising instructions for building a plurality of pallets for transporting the instances of the perishable item requested from each supplier using a minimum number of partial pallets; and exemplary means for generating a replenishment result comprising the optimized pallet build parameters for building the plurality of pallets with the minimum number of partial pallets and assignments of the plurality of pallets from the plurality of suppliers to the minimized number of transport vehicles for transport of the instances of the perishable item to the plurality of recipients with reduced transportation resource usage.

Other non-limiting examples provide one or more computer storage devices having a first computer-executable instructions stored thereon for providing dynamic perishable item replenishment from suppliers to distribution centers with minimized transportation resource usage. When executed by a computer, the computer performs operations including obtain dynamic replenishment data for a perishable item available from a plurality of suppliers for delivery to a plurality of recipients, the dynamic replenishment data comprising forecast daily demand data for the perishable item, current inventory data for the perishable item, and supplier constraint data; calculate, by a MILP cost minimization model using the dynamic replenishment data, a minimized number of transport vehicles for transporting requested instances of the perishable item from the plurality of suppliers to the plurality of recipients in conformance with the supplier constraints; assign the instances of the perishable item requested from the plurality of suppliers to a subset of vehicles in a plurality of available transport vehicles for transporting the instances of the perishable item from each supplier to each recipient in the plurality of recipients, wherein the subset of vehicles comprises the minimized number of transport vehicles capable of delivering all the instances of the perishable item to the plurality of recipients; generate, by a MILP pallet minimization model using the dynamic replenishment data, pallet build parameters customized for each supplier in the plurality of suppliers comprising instructions for building a plurality of pallets for transporting the instances of the perishable item requested from each supplier using a minimum number of partial pallets; and generate a replenishment result comprising the optimized pallet build parameters for building the plurality of pallets with the minimum number of partial pallets and assignments of the plurality of pallets from the plurality of suppliers to the minimized number of transport vehicles for transport of the instances of the perishable item to the plurality of recipients with reduced transportation resource usage.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic perishable item replenishment, the system comprising:
a plurality of available transport vehicles for transporting items to a recipient;
a processor; and
a computer-readable medium storing instructions that are operative upon execution by the processor to:
obtain dynamic replenishment data for a perishable item available for delivery to a plurality of recipients, the dynamic replenishment data comprising forecast daily demand data for the perishable item, current inventory data for the perishable item, and constraint data;
calculate, by a mixed integer linear programming (MILP) cost minimization model using the dynamic replenishment data, a minimized number of transport vehicles for transporting instances of the perishable item to the plurality of recipients in conformance with the constraint data;
assign the instances of the perishable item to a subset of vehicles in the plurality of available transport vehicles for transporting the instances of the perishable item to each recipient in the plurality of recipients, wherein the subset of vehicles comprises the minimized number of transport vehicles capable of delivering all the instances of the perishable item to the plurality of recipients;
generate, by a MILP pallet minimization model using the dynamic replenishment data, customized pallet build parameters comprising instructions for building a plurality of pallets for transporting the instances of the perishable item using a minimum number of partial pallets; and
generate a replenishment result comprising the customized pallet build parameters and assignments of the instances of the perishable item to the subset of vehicles for transporting the instances of the perishable item to the plurality of recipients with reduced transportation resource usage.

2. The system of claim 1, further comprising:
a set of robotic pallet building devices, wherein the instructions are further operative to:
build, by the set of robotic pallet building devices, each pallet in the plurality of pallets in accordance with the customized pallet build parameters; and
load each pallet in the plurality of pallets onto each vehicle in the subset of vehicles for delivery to a destination by a set of robotic loading devices and a set of conveyors.

3. The system of claim 1, the system comprising:
an autonomous transport vehicle within the subset of vehicles, and wherein the instructions are further operative to:
generate, by the MILP cost minimization model, optimized transport vehicle assignments assigning a plurality of pallets to each transport vehicle in the subset of vehicles, the optimized transport vehicle assignments customized for each supplier and each transport vehicle on a daily basis minimizing a number of less than truckload (LTL) transport vehicles utilized to transport perishable items from a supplier to a recipient; and
deliver, by the autonomous transport vehicle, at least one pallet in the plurality of pallets to at least one recipient in accordance with the optimized transport vehicle assignments.

4. The system of claim 1, wherein the instructions are further operative to:
assign a number of cases of perishable items delivered for each unique item identifier (UID) from each supplier to each recipient per day using a minimum number of LTL transport vehicles and a minimum number of partial pallets for each UID.

5. The system of claim 1, wherein the instructions are further operative to:
adjust daily order amounts of perishable items dynamically based on total demand and supply imbalance specified within an upper bound and a lower bound associated with recipient capacity.

6. The system of claim 1, wherein the instructions are further operative to:
update daily purchase orders (POs) for a supplier in real-time based on dynamic changes in supply or demand for a selected perishable item associated with a plurality of distribution centers (DCs).

7. The system of claim 1, wherein the instructions are further operative to:
identifying three or more suppliers to provide replenishment of the perishable item; and
allocating three or more transport vehicles for transport of the instances of the perishable item to the plurality of recipients, wherein the replenishment result comprises assignments of pallets containing instances of the perishable item to each vehicle in the three or more transport vehicles while minimizing a number of LTL vehicle occurrences and reducing a number of partial pallet occurrences.

8. A method for dynamic perishable item replenishment, the method comprising:
obtaining dynamic replenishment data for a perishable item, the dynamic replenishment data comprising forecast daily demand data for the perishable item, current inventory data for the perishable item, and constraint data;
calculating, by a mixed integer linear programming (MILP) cost minimization model using the dynamic replenishment data, a minimized number of transport vehicles for transporting instances of the perishable item to a plurality of recipients in conformance with the constraint data;
assigning the instances of the perishable item to a subset of vehicles in a plurality of available transport vehicles for transporting the instances of the perishable item to each recipient in the plurality of recipients, wherein the subset of vehicles comprises the minimized number of transport vehicles capable of delivering all the instances of the perishable item to the plurality of recipients;
generating, by a MILP pallet minimization model using the dynamic replenishment data, customized pallet build parameters comprising instructions for building a plurality of pallets for transporting the instances of the perishable item using a minimum number of partial pallets; and
generating a replenishment result comprising the customized pallet build parameters for building the plurality of pallets with the minimum number of partial pallets and assignments of the plurality of pallets to the minimized number of transport vehicles for transport of the instances of the perishable item to the plurality of recipients with reduced transportation resource usage.

9. The method of claim 8, further comprising:
automatically building, by a set of robotic pallet building devices, each pallet in the plurality of pallets in accordance with the customized pallet build parameters; and
automatically loading each pallet in the plurality of pallets onto each vehicle in the subset of vehicles for delivery to a destination using a set of robotic loading devices and a set of conveyors.

10. The method of claim 8, further comprising:
generate, by the MILP cost minimization model, optimized transport vehicle assignments, wherein a pallet are assigned to each transport vehicle in the subset of vehicles, and wherein the optimized transport vehicle assignments customized for each supplier and each transport vehicle on a daily basis minimizing a number of LTL transport vehicles utilized to transport perishable items from a supplier to a recipient.

11. The method of claim 8, further comprising:
assigning a number of cases of perishable items delivered for each item from each supplier to each recipient per day using a minimum number of LTL transport vehicles and minimum delivery cost by optimally assigning a minimum number of partial pallets from each supplier to each DC for each item.

12. The method of claim 8, further comprising:
adjusting daily order amounts of perishable items dynamically based on total demand and supply imbalance specified within an upper bound and a lower bound associated with recipient capacity.

13. The method of claim 8, further comprising:
dynamically updating daily POs and weekly POs for a plurality of suppliers in real-time based on dynamic changes in supply of the plurality of suppliers and demand for a selected perishable item from a plurality of distribution centers (DCs).

14. The method of claim 8, further comprising:
generating a multi-supplier split for the perishable item, wherein a desired number of instances of the perishable item is requested from at least three suppliers to provide replenishment of the perishable item.

15. One or more computer storage devices having computer-executable instructions stored thereon, which, upon execution by a computer, cause the computer to perform operations comprising:
obtaining dynamic replenishment data for a plurality of perishable items available from a plurality of suppliers for delivery to a plurality of distribution centers (DCs), the dynamic replenishment data comprising forecast daily demand data for the plurality of perishable items, current inventory data for the plurality of perishable items, and user-configurable constraint data;
calculating, by a mixed integer linear programming (MILP) cost minimization model using the dynamic replenishment data, a minimized number of transport vehicles for transporting instances of each perishable item from the plurality of suppliers to a plurality of DCs in conformance with supplier constraint data;
assigning the instances of each perishable item requested from the plurality of suppliers to a subset of vehicles in a plurality of available transport vehicles for transporting the instances of each perishable item from each supplier to each DC in the plurality of DCs, wherein the subset of vehicles comprises the minimized number of transport vehicles capable of delivering all the instances of the plurality of perishable items to the plurality of DCs;
generating, by a MILP pallet minimization model using the dynamic replenishment data, customized pallet build parameters comprising instructions for building a plurality of pallets for transporting the instances of the plurality of perishable items requested from each supplier using a minimum number of partial pallets; and
generating a replenishment result comprising the customized pallet build parameters for building the plurality of pallets with the minimum number of partial pallets and assignments of the plurality of pallets from the plurality of suppliers to the minimized number of transport vehicles for transport of the instances of each perishable item to the plurality of DCs with reduced transportation resource usage.

16. The one or more computer storage devices of claim 15, wherein the operations further comprise:
building, via a set of robotic pallet building devices, each pallet in the plurality of pallets in accordance with the customized pallet build parameters; and
loading each pallet in the plurality of pallets onto each vehicle in the subset of vehicles for delivery to a destination via a set of robotic loading devices and a set of conveyors.

17. The one or more computer storage devices of claim 15, wherein the operations further comprise:
generating, by the MILP cost minimization model, optimized transport vehicle assignments assigning a plurality of pallets to each transport vehicle in the subset of vehicles, the optimized transport vehicle assignments customized for each supplier and each transport vehicle on a daily basis minimizing a number of LTL transport vehicles utilized to transport perishable items from a supplier to a DC.

18. The one or more computer storage devices of claim 15, wherein the operations further comprise:
assigning a number of cases of perishable items delivered for each stock keeping unit (SKU) from each supplier to each DC per day using a minimum number of LTL transport vehicles and a minimum number of partial pallets for each SKU.

19. The one or more computer storage devices of claim 15, wherein the operations further comprise:
adjusting daily order amounts of perishable items dynamically based on total demand and supply imbalance specified within an upper bound and a lower bound associated with capacity of a DC.

20. The one or more computer storage devices of claim 15, wherein the operations further comprise:
dynamically updating weekly POs requesting a plurality of perishable items from a plurality of suppliers in real-time based on dynamic changes in supplier supply of the plurality of perishable items, forecast weekly demand for the plurality of perishable items at a store level, and forecast weekly demand for the plurality of perishable items at a DC level.
